(19) United States
(12) Patent Application Publication
(10) Pub. No.: US 2017/0239681 A1
(43) Pub. Date: Aug. 24, 2017

(54) SYSTEMS AND METHODS FOR A SPRAYER ADAPTER

(71) Applicant: Carlisle Fluid Technologies, Inc., Scottsdale, AZ (US)

(72) Inventors: William K. Bierie, Liberty Center, OH (US); Marvin D. Burns, Millbury, OH (US)

(21) Appl. No.: 15/438,491

(22) Filed: Feb. 21, 2017

Related U.S. Application Data
(60) Provisional application No. 62/299,540, filed on Feb. 24, 2016.

(51) Int. Cl. B05B 15/06; B05B 7/24

(52) U.S. Cl. CPC B05B 15/065; B05B 7/2478; B05B 7/2408

(57) ABSTRACT

A system includes a conversion sleeve having a first mounting feature and a second mounting feature. The first mounting feature is configured to couple the conversion sleeve to a fluid connection of a first spray component. The second mounting feature is configured to couple the conversion sleeve to an adapter. The adapter is configured to be coupled to a second spray component.

### CROSS REFERENCE TO RELATED APPLICATIONS

This application claims priority from and the benefit of U.S. Provisional Patent Application No. 62/299,540, entitled “SYSTEMS AND METHODS FOR A SPRAYER ADAPTER,” filed Feb. 24, 2016, which is hereby incorporated by reference in its entirety.

### BACKGROUND

The subject matter disclosed herein relates to sprayers, and more particularly, to a conversion adapter for connecting a sprayer to a fluid supply system.

Sprayers, such as spray guns, are used to apply a spray coating to a wide variety of target objects. Such sprayers are typically coupled to a fluid supply system (e.g., a fluid container, a fluid conduit, etc.) and may be coupled to an air source or other gas source. Typically, one or more components may be utilized for connecting the sprayer with the fluid supply system. In certain situations, the one or more components may be utilized to establish a permanent connection between the fluid supply system and the sprayer. Unfortunately, such a connection may cause damage to the sprayer and/or the fluid supply system, and may be costly to remove and/or replace. Furthermore, such a connection may limit the interchangeability between the fluid supply system and the sprayer. For example, one or more types of fluid containers may not be compatible with the permanent connection utilized to connect the sprayer and the fluid supply system.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a conversion sleeve having a first mounting feature and a second mounting feature. The first mounting feature is configured to couple the conversion sleeve to a fluid connection of a first spray component. The second mounting feature is configured to couple the conversion sleeve to an adapter. The adapter is configured to be coupled to a second spray component.

In a second embodiment, a system includes a conversion sleeve having a first mounting feature configured to couple the conversion sleeve to a fluid connection of a first spray component. The system also includes an adapter having a first end and a second end. The first end of the adapter is configured to couple to a second mounting feature of the conversion sleeve, and the second end is configured to couple to a second spray component.

In a third embodiment, a method includes coupling a first mounting feature of a conversion sleeve to a fluid connection of a first spray component. The method also includes coupling a second mounting feature of the conversion sleeve to an adapter and coupling the adapter to a second spray component.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a side view of an embodiment of a sprayer system with a conversion adapter system for coupling the sprayer to a fluid supply system (e.g., a fluid conduit or siphon feed container);

FIG. 2 is a side view of an embodiment of a sprayer system with a conversion adapter system for coupling the sprayer to a fluid supply system (e.g., a gravity feed container);

FIG. 3 is a cross-sectional side view of an embodiment of a sprayer system with the conversion adapter system of FIG. 2 for coupling the sprayer to a fluid supply system;

FIG. 4 is an exploded view of an embodiment of the conversion adapter system of FIG. 2, including a conversion sleeve, an adapter, and a fluid connection;

FIG. 5 is perspective view of an embodiment of the conversion adapter system of FIG. 4, where the conversion sleeve is coupled to the fluid connection, and the adapter is coupled to the conversion sleeve;

FIG. 6 is a schematic of an embodiment of a plurality of conversion sleeves and adapters that may be utilized for coupling the sprayer of FIG. 1 to various fluid containers;

FIG. 7 is a partial exploded view of an embodiment of the conversion sleeve and the adapter of FIG. 4, where the conversion sleeve includes a partial threaded ring;

FIG. 8 is a partial exploded view of an embodiment of the conversion sleeve and the adapter of FIG. 4, where the conversion sleeve includes one or more threaded tabs;

FIG. 9 is a partial exploded view of an embodiment of the conversion sleeve and the adapter of FIG. 4, where the conversion sleeve includes a single threaded tab; and

FIG. 10 is a partial exploded view of an embodiment of the conversion sleeve and the adapter of FIG. 4, where the conversion sleeve includes a threaded ring.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure are directed to a conversion adapter system for connecting a spray system to a fluid supply system (e.g., a fluid container, such as a gravity feed container or siphon feed container). Specifically, the conversion adapter system may include a conversion sleeve and an adapter. The conversion sleeve may be configured to engage a portion of the spray system, and the adapter (e.g., threaded connector) may be configured to engage a portion of the fluid supply system. Accordingly, a coupling between the conversion sleeve and the adapter may establish a coupling between the fluid supply system and the spray system. In this manner, the conversion sleeve and the adapter may be utilized to couple spray systems and various types of fluid supply systems that may otherwise be unable to connect. Furthermore, the coupling between the conversion sleeve and the adapter may be a removable and replaceable connection, thereby allowing for a plurality of connections between spray systems and various types of fluid supply systems.

The spray system may include a sprayer, such as a handheld manual spray gun, an automated spray unit (e.g., a robotic mounted spray unit), a spray booth mounted spray unit, or any other suitable spray device. The sprayer also may include a pneumatic driven spray device, which uses a gas (e.g., air) to help atomize a liquid, shape a spray of the liquid, operate a valve of the sprayer, or a combination thereof. The sprayer may include a rotary bell cup, which rotates a bell cup to help create a spray. The sprayer may include an electrostatic spray device, which generates an electric field to help attract a spray onto a target object. Furthermore, the sprayer may be a spray coating device configured to produce a spray of a coating material, such as paint, for creating a coating on a surface of an object. The fluid supply system may include a fluid source, a fluid conduit, a fluid container (e.g., a gravity feed fluid container, a siphon feed fluid container, a multi-fluid feed container), or any combination thereof.

More particularly, the conversion sleeve may include one or more mounting features that engage a fluid connection of a sprayer within the sprayer system. The fluid connection may include one or more components utilized to couple a fluid supply system to a fluid inlet of the sprayer, as further described in detail below. Specifically, in certain embodiments, the conversion sleeve may include mounting features to engage a partial thread or a tab of the fluid connection. For example, in certain embodiments, the conversion sleeve may be a threaded ring that includes various slots, partial threaded features, tabs, protrusions, or any combination thereof. In particular, the one or more mounting features of the conversion sleeve may securely engage the partial thread or tab of the fluid connection of the sprayer. Further, one or more different types of adapters (e.g., threaded adapter, spiral adapter, threaded connector, etc.) may couple with the conversion sleeve. In certain embodiments, different types of fluid containers (e.g., gravity feed fluid container, a siphon feed fluid container, a multi-feed feed container, disposable containers, etc.) may utilize different types of adapters. Accordingly, the conversion adapter system may allow for a variety of different fluid supply systems to be utilized interchangeably with the sprayer system, as further described in detail below.

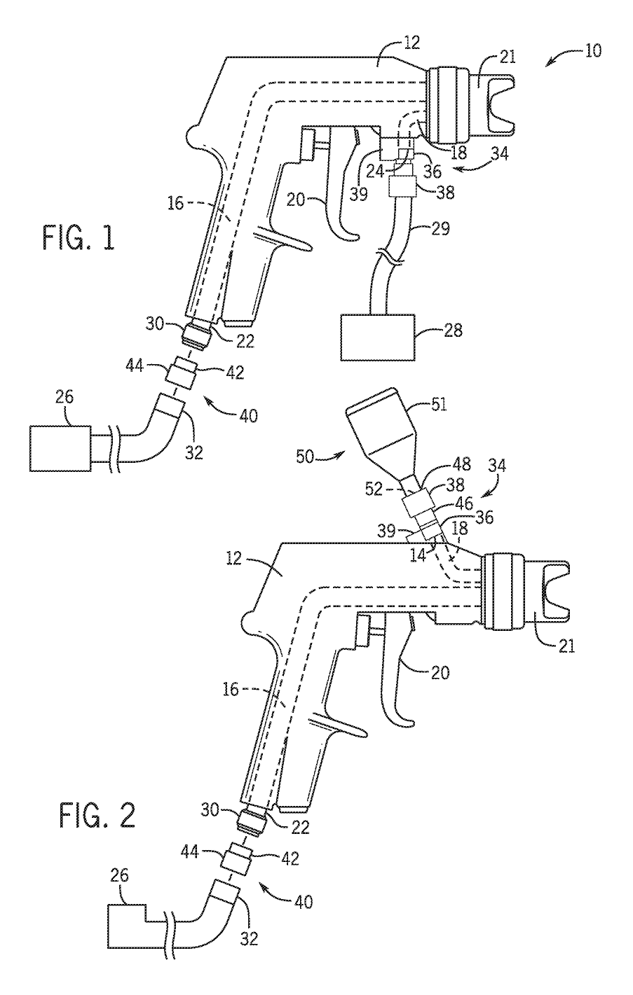

FIG. 1 is a side view of a sprayer system 10 including a spray component, such as a sprayer 12 for spraying a coating (paint, ink, varnish, etc.). The sprayer 12 may be any spray coating device (e.g., gravity-feed, siphon, high-volume low-pressure, or pressure) suitable for spraying coatings. The sprayer 12 includes a variety of passages, such as an air passage 16 and a fluid passage 18. In operation, a trigger 20 or other suitable control may send air and fluid through the air passage 16 and fluid passage 18 of the sprayer 12 enabling release of an air-fluid mixture through the nozzle 21.

The sprayer 12 may include an air inlet 22 and a fluid inlet 24 to receive air and fluids into the air passage 16 and the fluid passage 18 of the sprayer 12. The air inlet (i.e. port) 22 and the fluid inlet (i.e. port) 24 may be coupled to one or more spray components, such as an air source 26 and a fluid supply system 28 (e.g., a fluid conduit and/or siphon feed container). For example, the air inlet 22 may couple to an air compressor or an air reservoir (e.g., air tank). The air inlet 22 may couple to the air source 26 using a variety of connections. For instance, the air inlet 22 may include a connector 30 (e.g., male) and the air source 26 may include corresponding connector 32 (e.g., female). In some embodiments, the air inlet 22 may be a female connector 30 and the air source 26 may be a male connector 32. Similarly, the fluid inlet (i.e., port) 24 may couple to the fluid supply system 28, which may include a fluid source (e.g., paint mixer), a fluid conduit (e.g., hose) 29, a fluid reservoir (e.g., a gravity feed fluid container, a siphon feed fluid container, a multi-fluid feed container, disposable cup, fluid container), and/or another fluid supply system 28 using a variety of connections.

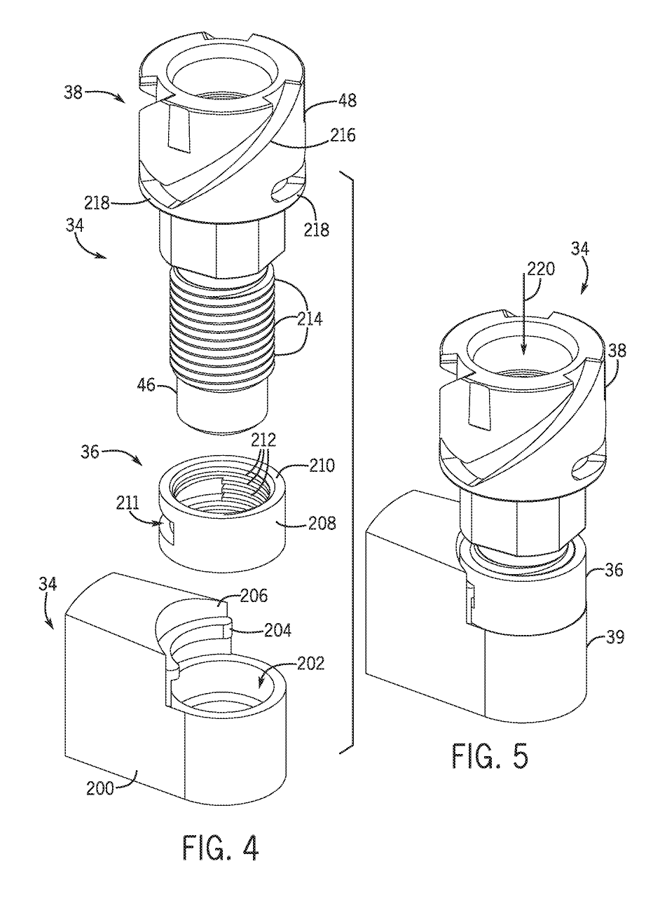

In certain embodiments, a conversion adapter system 34 may be utilized to couple the fluid supply system 28 to the sprayer 12. Specifically, the conversion adapter system 34 may include a conversion sleeve 36 and an adapter 38. In certain embodiments, the conversion sleeve 36 may be configured to engage one or more features of a fluid connection 39 (as further described with respect to FIG. 4). In particular, the fluid connection 39 may include one or more components that may be utilized to connect the fluid supply system 28 to the sprayer 12, thereby connecting the fluid inlet 24 of the sprayer 12 with the fluid supply system 28. For example, as further described with respect to FIG. 4, the fluid connection 39 may be a region on the sprayer 39 that includes one or more tabs, threaded features, and/or male or female connectors that may be utilized to connect the fluid supply system 28. In some cases, male and female connectors may utilize a press-fit and/or interference fit to couple the fluid supply system 28 to the sprayer 12 at the fluid connection 39. However, as noted above, such techniques may damage the sprayer 12 and/or create a permanent coupling between the sprayer 12 and the fluid supply system 28.

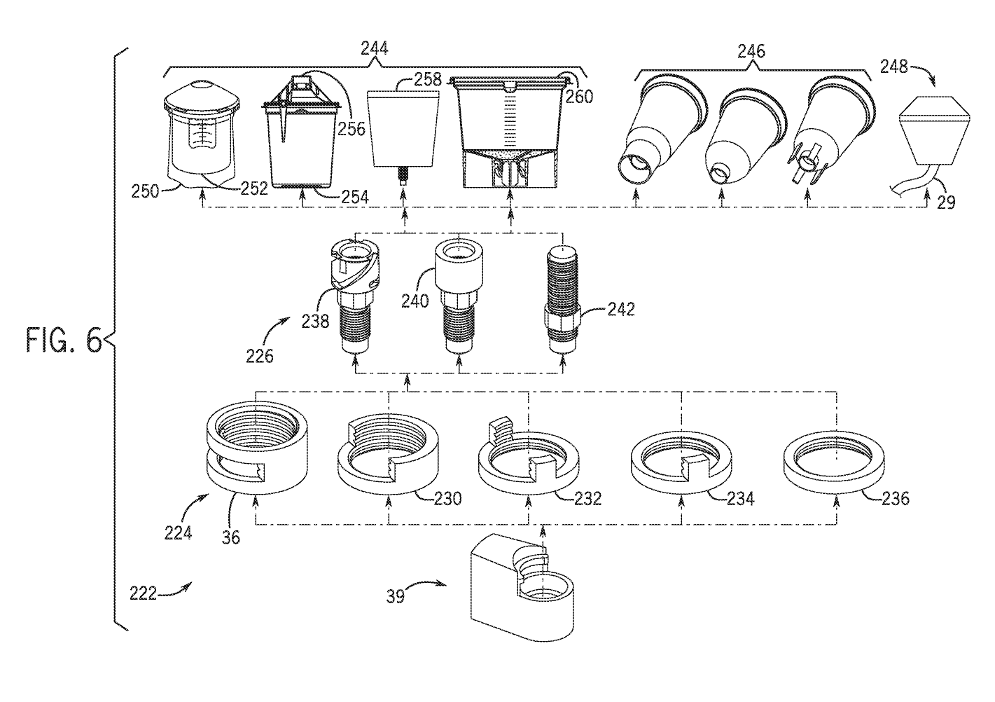

Accordingly, in certain embodiments, it may be desirable to use the conversion sleeve 36 in combination with the adapter 38 to couple the fluid supply system 28 to the sprayer 12 at the fluid connection 39 (i.e., forming a removable connection). In particular, utilizing the conversion sleeve 36 and the adapter 38 may create an interchangeable coupling between the sprayer 12 and the fluid supply system 28. Further, in certain embodiments, the conversion sleeve 36 and the adapter 38 may be utilized to retrofit an existing sprayer 12 to various types of fluid supply system 28, thereby creating a pairing between spray components that are not otherwise configured for a pairing. For example, the conversion sleeve 36 may include one or more mounting features that engage a partial thread and/or a tab of the fluid connection 39, as further described with respect to FIG. 4. The one or more mounting features of the conversion sleeve (e.g., various slots, partial threaded features, tabs, protrusions, or any combination thereof) may securely engage the partial thread or tab of the fluid connection 39. Further, the adapter 38 (e.g., threaded adapter, spiral adapter, threaded connector, etc.) may be removably coupled to the fluid supply system 28, and may couple with the conversion sleeve 36. In particular, different types of fluid supply systems 28 may utilize different types of adapters 38, as further described with respect to FIG. 6. Accordingly, the conversion adapter system 34 may be utilized to couple the fluid supply system 28 to the sprayer 12.

In some cases, a connector 40 may connect the sprayer 12 to the air source 26. The connector 40 may include a sprayer connector 42 and a source connector 44. The sprayer connector 42 may couple the connector 40 to the inlet 22 of the sprayer 12, and the source connector 44 may couple the connector 40 to the connector 32 of the air source 26. However, it should be noted that in certain embodiments, the conversion adapter system 34 may be utilized to couple the air source 26 to the sprayer 12.

The sprayer 12 may be any suitable coating device, such as a gravity-feed, siphon, high-volume low-pressure, or pressure spray gun. For example, FIG. 2 illustrates a sprayer system 10 (e.g., gravity-fed) having a sprayer 12 with the conversion adapter system 34 (e.g., the adapter 38 and the conversion sleeve 36) that couples a gravity-fed fluid supply system 50 to the sprayer 12. In some embodiments, the gravity-fed fluid supply system 50 may include a fluid source 51 (e.g., gravity feed container or cup) that may be a disposable cup. In FIG. 2, the sprayer system 10 uses gravity to force fluid from the fluid source 51 through the adapter 38 and the conversion sleeve 36 and into the fluid inlet 24 of the passage 18. In certain embodiments, the adapter 38 may include a sleeve connector 46 that engages with the conversion sleeve 36 and a fluid connector 48 that engages with a gravity-fed fluid inlet 52 of the fluid source 51.

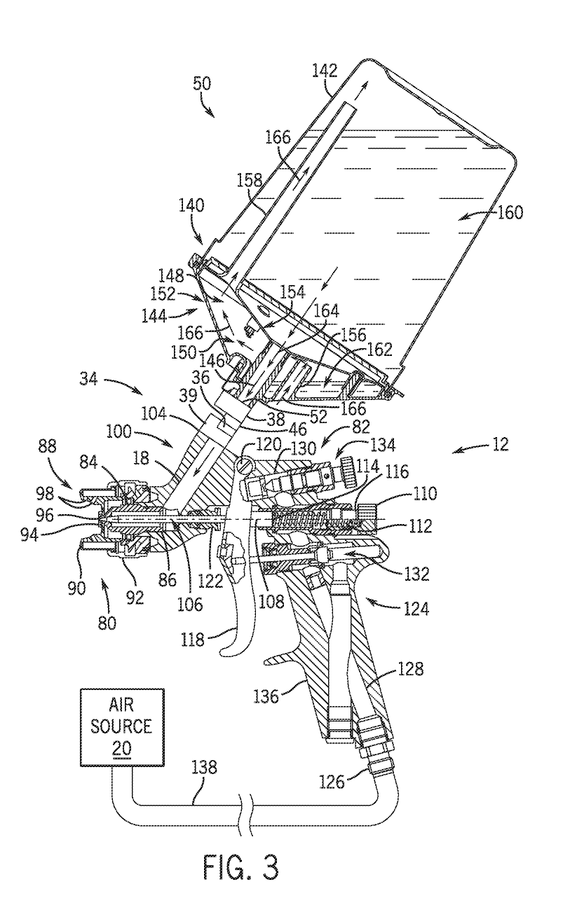

FIG. 3 is a cross-sectional side view illustrating an embodiment of the sprayer 12 coupled to the gravity-fed fluid supply system 50. As illustrated, the sprayer 12 includes a spray tip assembly 80 coupled to a body 82. The spray tip assembly 80 includes a liquid delivery tip assembly 84, which may be removably inserted into a receptacle 86 of the body 82. For example, a plurality of different types of spray coating devices may be configured to receive and use the liquid delivery tip assembly 84. The spray tip assembly 80 also includes a spray formation assembly 88 coupled to the liquid delivery tip assembly 84. The spray formation assembly 88 may include a variety of spray formation mechanisms, such as air, rotary, and electrostatic atomization mechanisms. However, the illustrated spray formation assembly 88 comprises an air atomization cap 90, which is removably secured to the body 82 via a retaining nut 92. The air atomization cap 90 includes a variety of air atomization orifices, such as a central atomization orifice 94 disposed about a liquid tip exit 96 from the liquid delivery tip assembly 94. The air atomization cap 90 also may have one or more spray shaping air orifices, such as spray shaping orifices 98, which use air jets to force the spray to form a desired spray pattern (e.g., a flat spray). The spray formation assembly 88 also may include a variety of other atomization mechanisms to provide a desired spray pattern and droplet distribution.

The body 82 of the sprayer 12 includes a variety of controls and supply mechanisms for the spray tip assembly 80. As illustrated, the body 82 includes a liquid delivery assembly 100 having a fluid passage 18 extending from a liquid inlet coupling 104 to the liquid delivery tip assembly 84. In particular, as noted above, the conversion adapter system 34 may be utilized to couple the fluid supply system 50 to the sprayer 12 at the liquid inlet coupling 104. Specifically, the conversion sleeve 36 of the conversion adapter system 34 may be configured to couple with the fluid connection 39 of the sprayer 12. In the illustrated embodiment, the fluid connection 39 may be integral with the body 82 of the sprayer 12. Further, the conversion sleeve 36 may be removably coupled with the fluid connection 39, such that one or more different conversion sleeves 36, having one or more different mounting features, may be removably coupled with the fluid connection 39. Further, as noted above, the adapter 38 may include the sleeve connector 46 that engages with the conversion sleeve 36 and a fluid connector 48 that engages with a gravity-fed fluid inlet 52 of the fluid source 51. In this manner, the liquid conduit 146 of the cover assembly 144 is fluidly coupled through the conversion adapter system 34 to the liquid passage 18 of the sprayer 14.

The liquid delivery assembly 100 also includes a liquid valve assembly 106 to control liquid flow through the fluid passage 18 and to the liquid delivery tip assembly 84. The illustrated liquid valve assembly 106 has a needle valve 108 extending movably through the body 82 between the liquid delivery tip assembly 84 and a liquid valve adjuster 110. The liquid valve adjuster 110 is rotatably adjustable against a spring 112 disposed between a rear section 114 of the needle valve 108 and an internal portion 116 of the liquid valve adjuster 110. The needle valve 108 is also coupled to a trigger 118, such that the needle valve 108 may be moved inwardly away from the liquid delivery tip assembly 84 as the trigger 118 is rotated counter clockwise about a pivot joint 120. However, any suitable inwardly or outwardly openable valve assembly may be used within the scope of the present technique. The liquid valve assembly 106 also may include a variety of packing and seal assemblies, such as packing assembly 122, disposed between the needle valve 108 and the body 82.

An air supply assembly 124 is also disposed in the body 82 to facilitate atomization at the spray formation assembly 88. The illustrated air supply assembly 124 extends from an air inlet coupling 126 to the air atomization cap 90 via air passages 128 and 130. The air supply assembly 124 also includes a variety of seal assemblies, air valve assemblies, and air valve adjusters to maintain and regulate the air pressure and flow through the sprayer 12. For example, the illustrated air supply assembly 124 includes an air valve assembly 132 coupled to the trigger 118, such that rotation of the trigger 118 about the pivot joint 120 opens the air valve assembly 132 to allow air flow from the air passage 128 to the air passage 130. The air supply assembly 124 also includes an air valve adjustor 134 to regulate the air flow to the air atomization cap 90. As illustrated, the trigger 118 is coupled to both the liquid valve assembly 106 and the air valve assembly 132, such that liquid and air simultaneously flow to the spray tip assembly 80 as the trigger 118 is pulled toward a handle 136 of the body 82. Once engaged, the sprayer 12 produces an atomized spray with a desired spray pattern and droplet distribution.

In the illustrated embodiment of FIG. 3, the air source 26 is coupled to the air inlet coupling 126 via air conduit 138. Embodiments of the air source 26 may include an air compressor, a compressed air tank, a compressed inert gas tank, or a combination thereof. In the illustrated embodiment, the fluid supply system 50 is directly mounted to the sprayer 12. The illustrated fluid supply system 50 includes a container assembly 140, which includes a container 142 and a cover assembly 144. In some embodiments, the container 142 may be a flexible cup made of a suitable material, such as polypropylene. Furthermore, the container 142 may be disposable, such that a user may discard the container 142 after use.

The cover assembly 144 includes a liquid conduit 146 and a vent system 148. The vent system 148 includes a buffer chamber 150 disposed between an outer cover 152 and an inner cover 154. The liquid conduit 146 is coupled to the inner and outer covers 152 and 152, and extends through the buffer chamber 150 without any liquid openings in communication with the buffer chamber 150. The vent system 148 also includes a first vent conduit 156 coupled to the outer cover 152 and terminating within the buffer chamber 150, and a second vent conduit 158 coupled to the inner cover 154 and terminating outside of the buffer chamber 150 within the container 142. In other words, the first and second vent conduits 158 have openings in communication with one another through the buffer chamber 150.

In certain embodiments, all or some of the components of the container assembly 140 may be made of a disposable and/or recyclable material, such as a transparent or translucent plastic, a fibrous or cellulosic material, a non-metallic material, metallic material, or some combination thereof. For example, the container assembly 140 may be made entirely or substantially (e.g., greater than 75, 80, 85, 90, 95, 99 percent) from a disposable and/or recyclable material. Embodiments of a plastic container assembly 140 include a material composition consisting essentially or entirely of a polymer, e.g., polyethylene. Embodiments of a fibrous container assembly 140 include a material composition consisting essentially or entirely of natural fibers (e.g., vegetable fibers, wood fibers, animal fibers, or mineral fibers) or synthetic/man-made fibers (e.g., cellulose, mineral, or polymer). Examples of cellulose fibers include modal or bamboo. Examples of polymer fibers include nylon, polyester, polyvinyl chloride, polyolefins, aramids, polyethylene, elastomers, and polyurethane. In certain embodiments, the cover assembly 144 may be designed for a single use application, whereas the container 142 may be used to store a liquid (e.g., liquid paint mixture) between uses with different cover assemblies 144. In other embodiments, the container 142 and the cover assembly 144 may both be disposable and may be designed for a single use or multiple uses before being discarded.

As further illustrated in FIG. 3, the container assembly 140 is coupled to the sprayer 12 overhead in a gravity feed configuration. During setup, the container assembly 140 may be filled with a coating liquid (e.g., paint) in a cover side up position separate from the sprayer 12, and then the container assembly 140 may be flipped over to a cover side down position for connection with the sprayer 12. As the container 142 is flipped over, a portion the coating liquid leaks or flows through the vent conduit 158 into the buffer chamber 150, resulting in a first liquid volume 160 in the container 142 and a second liquid volume 162 in the buffer chamber 150. However, at least some of the liquid remains the vent conduit 158 due to a vacuum pressure in the container 142, a surface tension within the vent conduit 158, and a surface tension at a distal end opening of the vent conduit 158. The buffer chamber 150 is configured to hold the liquid volume 162 that leaked from the container 142 as the container 142 is rotated between a cover side up position and a cover side down position. During use of the sprayer 12, the coating liquid flows from the container 142 to the sprayer 12 along fluid flow path 164. Concurrently, air enters the container 142 via air flow path 166 through the vent system 148. That is, air flows into the first vent conduit 156, through buffer chamber 150, through the second vent conduit 158, and into the container 142. As discussed in further detail below, the buffer chamber 150 and orientation of the vent conduits 156 and 158 maintains the air flow path 166 (e.g., vent path) in all orientations of the container assembly 140 and sprayer 12, while holding leaked coating liquid (e.g., second liquid volume 162) away from openings in the vent conduits 156 and 158. For example, the vent system 148 is configured to maintain the air flow path 166 and hold the liquid volume 162 in the buffer chamber 150 as the container assembly 140 is rotated approximately 0 to 360 degrees in a horizontal plane, a vertical plane, or any other plane.

FIG. 4 is an exploded view of an embodiment of the conversion adapter system 34 of FIG. 1. In particular, the conversion adapter system 34 includes the conversion sleeve 36 and the adapter 38. As noted above with respect to FIGS. 1-3, the conversion sleeve 36 of the conversion adapter system 34 may be configured to removably couple with the fluid connection 39 of the sprayer 12. In certain embodiments, a body 200 of the fluid connection 39 may be integral with the body 82 of the sprayer 12. Further, the fluid connection 39 may include a fluid passage or bore with an annular recessed portion or cup 202 that allows fluid (e.g., paint, ink, varnish, etc.) to pass through the conversion adapter system 34 and to the fluid passage 18 of the sprayer 12. In particular, the fluid connection 39 may include one or more features that couple with the conversion sleeve 36 of the conversion adapter system 34. Specifically, the fluid connection 39 may include a partial thread 204 (e.g., one or more C-shaped tabs or protrusions) that is configured to couple with the conversion sleeve 36. In certain embodiments, the fluid connection 39 may include a connecting surface 206 surrounding the partial thread 204 that is configured to mate with a connecting surface 208 of the conversion sleeve 36. In the illustrated embodiment, the partial thread 204 may protrude from the connecting surface 206. Further, it should be noted that in certain embodiments, one or more partial threads 204 may be disposed on the connecting surface 206. For example, the partial thread 204 may be a single partial thread (i.e., only one row) which extends only partially circumferentially about an axis of the bore 202. In other embodiments, one or more tabs or protrusions may be spaced apart from one another circumferentially about the axis and/or axially along the axis. In the illustrated embodiment, the conversion sleeve 36 is ring-shaped, such that the connecting surfaces 208 complements the cylindrical connecting surface 206 of the fluid connection 39. It should be noted that in other embodiments, the connecting surfaces 206, 208 may be differently shaped.

In certain embodiments, the conversion sleeve 36 may be a single-piece threaded ring 210 having one or more threads 212 and a slot 211. In particular, the slot 211 may be configured to couple with the partial thread 204 of the fluid connection 39. For example, in the illustrated embodiment, the slot 211 may engage with the partial thread 204 when the conversion sleeve 36 is coupled with the fluid connection 39. Accordingly, in certain embodiments, the shape and the size of the slot 211 may complement the shape and size of the partial thread 204 of the fluid connection 39 to provide a snug and secure fit. In certain embodiments, the conversion sleeve 36 is rotatably engaged with the fluid connection 39 until the slot 211 and the partial thread 204 interlock to create a secure connection. Furthermore, the interlocked connection between the slot 211 and the partial thread 204 may prevent the connection between the adapter 38 and the conversion sleeve 36 from separating (thereby preventing the connection between the sprayer 12 and the fluid supply system 28 from separating). The threads 212 may include a plurality of breaks or variations in geometry, and may threadingly engage corresponding threads 214 of the adapter 38. The threading 212, 214 may be a single, multi-start, or three start thread. In certain embodiments, the threads 212 may complement the spiraling threads 214 of the adapter 38.

In certain embodiments, the adapter 38 may include the sleeve connector 46 that engages with the conversion sleeve 36 and the fluid connector 48 that engages with the fluid source 50. In certain embodiments, the adapter 38 may include any suitable combination of male or female fluid connector 48, and may include any suitable form of coupling to the conversion sleeve 36. In certain embodiments, the adapter 38 may be suitable and/or may be associated with a type of fluid supply system 28 and/or fluid container assembly 140. For example, the adapter 38 may be a quick disconnect adapter, a snap-fit adapter, gripping adapter, a spiral groove adapter, any threaded connector, an adapter with a self-tapping portion, or any type of adapter that provides the benefit of coupling the sprayer 12 to fluid sources (e.g., conduits, containers, etc.) that are otherwise unable to couple due to incompatible couplings. In certain embodiments, the adapter 38 may include one or more non-threaded connections for connecting the fluid connector 48 to the fluid source 50. For example, the fluid connector 48 in the illustrated embodiment may rotatably engage the liquid conduit 146 of the fluid supply system 28 until the one or more spiral grooves 216 interlock with corresponding protrusions (e.g., radial tabs or pins) of the fluid supply systems 28. In certain embodiments, the bend 218 of the fluid connector 28 may be utilized to secure the adapter 38 to the fluid supply system 28, and to prevent the connection between the two from separating. It should be noted that while the illustrated embodiment depicts the adapter 38 with spiral grooves 216, any type of adapter 38 may be utilized to couple to the conversion sleeve 36 and the fluid connection 39.

In certain embodiments, the adapter 38 may be formed of adapter material such as stainless steel, aluminum, plastic, nylon, a ceramic, carbide (e.g., tungsten carbide), tool steel, or any combination thereof. In certain embodiments, the adapter 38 may be formed of plastic, tin, copper, brass, lead, bronze, or any other material suitable for an adapter. In certain embodiments, the conversion sleeve may be formed of conversion sleeve material, such as a stainless steel. However, it should be noted that in certain embodiments, the conversion sleeve (and/or any portion or feature of the conversion sleeve 34) may be formed of aluminum, nylon, a ceramic, carbide (e.g., tungsten carbide), tool steel, plastic, tin, copper, brass, lead, bronze, or any other material suitable for the conversion sleeve 38.

FIG. 5 is perspective view of an embodiment of the conversion adapter system 34 of FIG. 4. In the illustrated embodiment, the conversion sleeve 36 is coupled to the fluid connection 39 and the adapter 38 is coupled to the conversion sleeve 36. In particular, the conversion sleeve 36 may be removably and rotatably coupled to the fluid connection 39, such that the adapter 38 is retained by force applied through the conversion sleeve 36 to the partial thread 204, without directly engaging the partial thread 204 of the fluid connection 39. In this manner, the conversion adapter system 34 may utilize existing features of the sprayer 12 (e.g., the partial thread 204 of the fluid connection 39) to create removable couplings between the sprayer 12 and one or more different types of fluid supply systems 28, as further described in detail with respect to FIG. 6. Furthermore, it should be noted that when the conversion adapter system 34 is installed and/or coupled with fluid connection 39, an internal passage 220 allows fluid or air to flow from the fluid supply system 28 to the sprayer 12. The internal passage 220 may be a cylindrical or other suitable shape that enables liquids and/or air to pass through the conversion adapter system 34.

FIG. 6 is a schematic of an embodiment of a plurality of conversion sleeves 36 and adapters 38 that may be utilized for coupling the sprayer 12 of FIG. 1 to various fluid containers 142. As noted above, the conversion sleeve 36 described in FIGS. 4 and 5 may be a threaded ring having various mounting features, such as slots, partial threaded features, tabs, protrusions, lugs and grooves, tapered portions, threaded helical portions, threaded spiral portions, or any combination thereof. In particular, a variety of different conversion sleeves 36, having one or more different mounting features, may be utilized to couple the adapter 38 with the fluid connection 39 of the sprayer 12. Similarly, as noted above, different types of fluid containers 142 (e.g., gravity feed fluid container, a siphon feed fluid container, a multi-feed feed container, disposable containers, etc.) associated with different fluid supply systems 28 may utilize different types of adapters 38. In particular, a variety of different types of fluid containers 142 may be coupled to the fluid connection 39 via an associated adapter 38 and a desired conversion sleeve 36, as further described in detail below.

In the illustrated embodiment, an interchangeable family 222 of conversion sleeves 36, adapters 38, and fluid containers 142 are depicted. In particular, based on the type of fluid container 142 desired, a plurality of different types of conversion adapter systems 24 may be formed. More specifically, a family of conversion sleeves 224 may include the conversion sleeve 36 with the slot 211, a partial-ring conversion sleeve 230, a conversion sleeve 232 with a plurality of tabs, a conversion sleeve 243 with a single tab, a threaded-ring conversion sleeve, or conversion sleeves 36 with any number or combination of mounting features. A family of adapters 226 may include a spiral groove adapter 238, any threaded connector 240, a gripping adapter 242, or any adapter 38 that may be utilized to couple the fluid container 142 on a first end and the conversion sleeve 36 on a second end. Furthermore, a family of fluid containers 142 may include gravity feed fluid containers 244, a siphon feed fluid container 248 (coupled to a fluid conduit 29), one or more disposable containers 246 each having different connection features, and/or any other type of multi-feed feed container or fluid container 142.

In certain embodiments, various types of gravity feed fluid containers 244 having different container assemblies and different connection methods may be utilized. For example, the fluid container 250 includes a reusable cup holder 250 having a disposable inner cup 252. The disposable inner cup 252 may be filled with fluid, and may be discarded after use. As a further example, the fluid container 254 includes a removably coupled outer lid 256 that is configured to fit over the disposable inner cup 252. In particular, the fluid containers 250, 254 may include one or more features on the outer lid for connecting to the adapter 38 (or family of adapters 226). As a further example, the fluid container 260 may include a filter assembly that is removably mounted inside of the fluid container 260 and the fluid container 258 may be a fluid container without a filter assembly. In particular, the fluid containers 258, 260 may include features (e.g., threaded connection) on a bottom surface of the cup for coupling to the adapter 38 (or family of adapters 226).

Accordingly, one or more different types of fluid containers 142 may be coupled to the fluid connection 39 of the sprayer 12 via the conversion adapter system 34. In particular, based on the type the fluid container 142 desired and/or the type of the sprayer 12, a conversion sleeve from the family of conversion sleeves 224 and an adapter from the family of adapters 226 may be utilized. Accordingly, a plurality of conversion adapter systems 34 may be designed and utilized, providing flexibility in coupling various fluid containers 142 with the sprayer 12. In this manner, fluid supply systems 28 (e.g., containers, fluid conduits, etc.) that cannot otherwise be coupled with the sprayer 12 may be paired via the conversion adapter system 34.

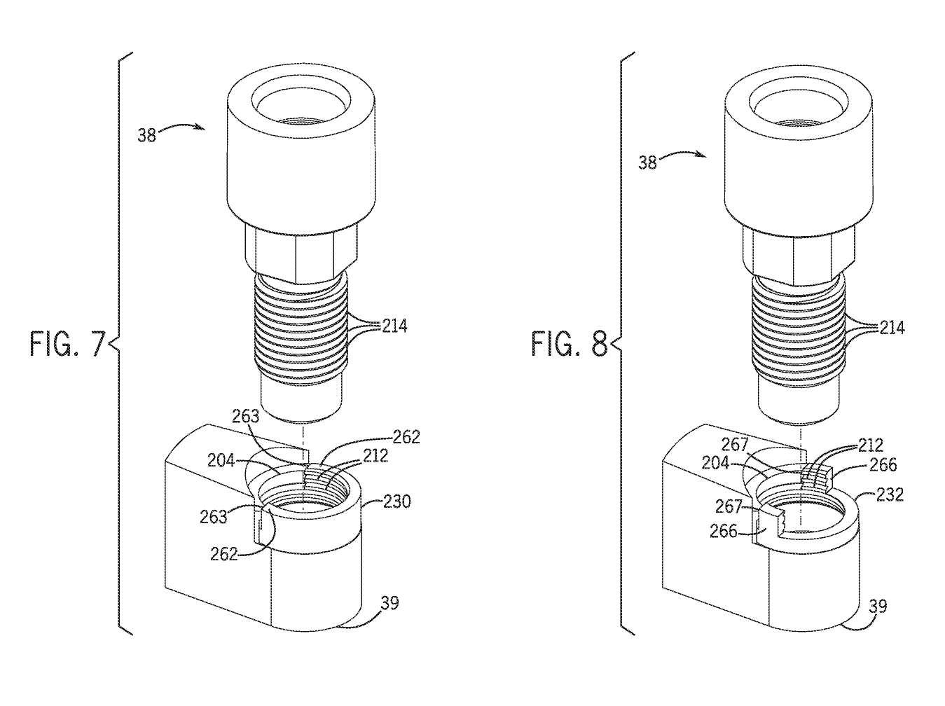

FIG. 7 is a partial exploded view of an embodiment of the conversion sleeve 36 and the adapter 38 of FIG. 4, where the conversion sleeve 36 is a partial-ring conversion sleeve 230. In particular, the partial-ring conversion sleeve 230 may include a region within the threaded ring of the conversion sleeve complementing the partial thread 104 of the fluid connection 39. In certain embodiments, the partial-ring conversion sleeve 230 may utilize the threads 212 of the threaded ring to couple with the threads 214 of the adapter 38. Further, the partial-ring conversion sleeve 230 may couple with the partial thread 204 of the fluid connection 39, such that connecting surfaces 262 of the partial-ring conversion sleeve 230 may complement the edges of the partial thread 204. In particular, the adapter 38 may be retained by force applied through the partial-ring conversion sleeve 230 to the partial thread 204, without directly engaging the partial thread 204 of the fluid connection 39. While the illustrated embodiment depicts the adapter 38, it should be noted that any adapter 38 from the family of adapters 226 may be utilized to couple with the partial-ring conversion sleeve 230.

FIG. 8 is a partial exploded view of an embodiment of the conversion sleeve 36 and the adapter 38 of FIG. 4, where the conversion sleeve 232 includes two or more threaded tabs 266. In particular, the two or more threaded tabs 266 may create a region there between that complement the size and shape of the partial thread 104 of the fluid connection 39. Specifically, the two or more threaded tabs 266 may each include connecting surfaces 267 that complement the edges of the partial thread 204 for a snug and secure fit. In certain embodiments, the two or more threaded tabs 266 may include anti-rotation features that prevent the conversion sleeve 232 from rotating about the partial thread 204. For example, the two or more threaded tabs 266 may be disposed on opposite sides of the partial thread 204, thereby helping to reduce rotational movement of the conversion sleeve 232 about the partial thread 204. Further, as noted above, the threads 212 of the two or more threaded tabs 266 of the conversion sleeve 232 may be utilized to couple with the threads 214 of the adapter 38. In particular, the adapter 38 may be retained by force applied through the conversion sleeve 232 with the two or more threaded tabs 266 to the partial thread 204, without directly engaging the partial thread 204 of the fluid connection 39. Further, the adapter 38 may extend completely through the conversion sleeve 232 and into the bore of the fluid connection 39, thereby helping to stabilize the connection and securing the interlock between the conversion sleeve 232, the adapter 38, and the fluid connection 39.

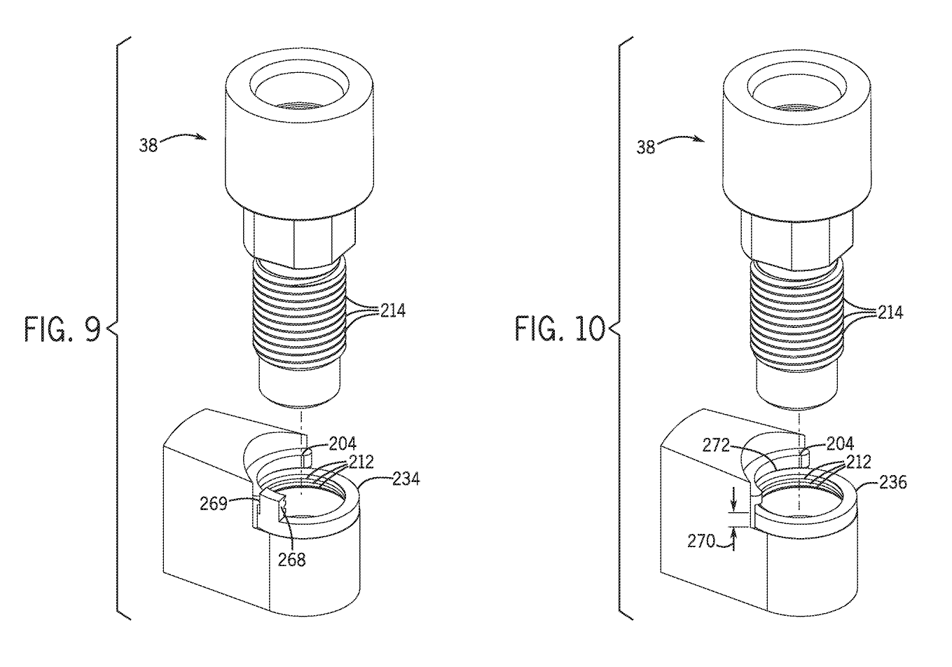

FIG. 9 is a partial exploded view of an embodiment of the conversion sleeve 36 and the adapter 38 of FIG. 4, where the conversion sleeve 234 includes a single threaded tab 268. As noted above, the threads 212 of the single threaded tab 268 of the conversion sleeve 234 may be utilized to couple with the threads 214 of the adapter 38. Further, the single threaded tab 268 may include a connecting surface 269 that complements an edge of the partial thread 204 for a snug and secure fit. In certain embodiments, the single threaded tab 268 may include anti-rotation features that prevent the conversion sleeve 234 from rotating about the partial thread 204 along one or more directions. For example, the single threaded tab 268 may be disposed along a side of the partial thread 204, thereby helping to reduce rotational movement of the conversion sleeve 234 about the partial thread 204. In particular, the adapter 38 may be retained by force applied through the conversion sleeve 234 with the single threaded tab 268 to the partial thread 204, without directly engaging the partial thread 204 of the fluid connection 39. Further, the adapter 38 may extend completely through the conversion sleeve 234 and into the bore of the fluid connection 39, thereby helping to stabilize the connection and securing the interlock between the conversion sleeve 234, the adapter 38, and the fluid connection 39.

FIG. 10 is a partial exploded view of an embodiment of the conversion sleeve 36 and the adapter 38 of FIG. 4, where the conversion sleeve 236 includes a threaded ring that fits in a distance 270 below the partial thread 204 of the fluid connection 39. In particular, the threaded ring of the conversion sleeve 236 may include a connecting surface 272 that complements an edge of the partial thread 204 for a snug and secure fit. In particular, the adapter 38 may be retained by force applied through the conversion sleeve 236 to the partial thread 204, without directly engaging the partial thread 204 of the fluid connection 39. Further, the adapter 38 may extend completely through the conversion sleeve 236 and into the bore of the fluid connection 39, thereby helping to stabilize the connection and securing the interlock between the conversion sleeve 236, the adapter 38, and the fluid connection 39.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a conversion sleeve, comprising:
a first mounting feature configured to couple the conversion sleeve to a fluid connection of a first spray component; and
a second mounting feature configured to couple the conversion sleeve to an adapter, wherein the adapter is configured to be coupled to a second spray component.

2. The system of claim 1, wherein the first spray component comprises a sprayer, and the second spray component comprises a fluid source assembly.

3. The system of claim 1, wherein the second spray component comprises a fluid container of a fluid source assembly.

4. The system of claim 3, wherein the fluid container comprises a gravity feed fluid container, a siphon feed fluid container, a multi-feed feed container, or a disposable container.

5. The system of claim 1, wherein the first mounting feature comprises a slot configured to couple to a partial thread of the fluid connection.

6. The system of claim 1, wherein the first mounting feature comprises one or more threaded tabs configured to couple to a partial thread of the fluid connection.

7. The system of claim 1, wherein the conversion sleeve comprises a threaded ring configured to couple to a partial thread of the fluid connection.

8. The system of claim 1, wherein the second mounting features comprises threads configured to couple with the adapter, and wherein the adapter comprises a threaded connector.

9. The system of claim 1, wherein the adapter comprises a spiral groove adapter or a gripping adapter.

10. A system, comprising:
a conversion sleeve comprising a first mounting feature configured to couple the conversion sleeve to a fluid connection of a first spray component; and
an adapter comprising a first end and a second end, wherein the first end is configured to couple to a second mounting feature of the conversion sleeve, and wherein the second end is configured to couple to a second spray component.

11. The system of claim 10, wherein the first spray component comprises a sprayer, and the second spray component comprises a fluid source assembly.

12. The system of claim 10, wherein the second spray component comprises a fluid container of a fluid source assembly.

13. The system of claim 12, wherein the fluid container comprises a gravity feed fluid container, a siphon feed fluid container, a multi-feed feed container, or a disposable container.

14. The system of claim 12, wherein the first mounting feature comprises a slot or one or more threads configured to couple to a partial thread of the fluid connection.

15. The system of claim 12, wherein the adapter comprises a spiral groove adapter, a threaded connection, or a gripping adapter.

16. A method, comprising:
coupling a first mounting feature of a conversion sleeve to a fluid connection of a first spray component;
coupling a second mounting feature of the conversion sleeve to an adapter; and
coupling the adapter to a second spray component.

17. The method of claim 16, wherein coupling the first mounting feature of the conversion sleeve comprises coupling the first mounting feature of the conversion sleeve to a partial thread of a fluid connection of a sprayer.

18. The method of claim 16, wherein coupling the adapter comprises coupling the adapter to a fluid container of a fluid source assembly.

19. The method of claim 18, wherein coupling the adapter comprises coupling the adapter to a gravity feed fluid container, a siphon feed fluid container, a multi-feed feed container, or a disposable container.

20. The method of claim 16, wherein coupling the second mounting feature comprises coupling the second mounting feature of the conversion sleeve to a threaded connector.
